(19) United States
(12) Patent Application Publication
(10) Pub. No.: US 2016/0048682 A1
(43) Pub. Date: Feb. 18, 2016

(54) Method and Apparatus for Clearing Malicious Power-Consuming Application, and User Terminal

(71) Applicant: Huawei Technologies Co., Ltd., Shenzhen (CN)

(72) Inventors: Junwei Gou, Shanghai (CN); Wei Li, Wuhan (CN); Zhishan Zhuang, Shanghai (CN)

(21) Appl. No.: 14/927,545

(22) Filed: Oct. 30, 2015

Related U.S. Application Data
(63) Continuation of application No. PCT/CN2014/078623, filed on May 28, 2014.

(30) Foreign Application Priority Data
Jun. 17, 2013 (CN) 201310239851.7

(51) Int. Cl. G06F 21/56

(52) U.S. Cl. CPC G06F 21/56; G06F 2221/033

(57) ABSTRACT

A method and an apparatus for clearing a malicious power-consuming application, and a user terminal are provided. An application whose background working power consumption is not less than a power consumption threshold is determined as a malicious power-consuming application; and a wakelock occupying time of each application if a screen is turned off is periodically calculated, and if a background working application's wakelock occupying time is not less than a set time threshold, the application is determined as a malicious power-consuming application.

### CROSS-REFERENCE TO RELATED APPLICATIONS

This application is a continuation of International Application No. PCT/CN2014/078623, filed on May 28, 2014, which claims priority to Chinese Patent Application No. 201310239851.7, filed on Jun. 17, 2013, both of which are hereby incorporated by reference in their entireties

### TECHNICAL FIELD

The present disclosure relates to the field of user terminal devices, and in particular, to a method and an apparatus for clearing a malicious power-consuming application, and a user terminal.

### BACKGROUND

At present, for many user terminals, especially intelligent terminals, due to improved processing capabilities, increasingly big screens, and increasingly high resolution, as well as high-speed wireless networks such as WIFI, third generation (3G), and long-term evolution (LTE) networks that are supported, a problem of severe power consumption generally exits. For example, longest standby time of many smart phones or tablet computers is generally shorter than one day, and users need to frequently charge them to ensure normal use, which results in great inconvenience.

In addition, at present, an intelligent terminal can support multiple applications, while some open application markets are full of undesirable applications. After a user downloads and installs these applications, these applications improperly occupy system resources of the intelligent terminal, including occupying the central processing unit (CPU) for a long time, maintaining the system in an active state for a long time, consuming traffic secretly in the background, using various sensors secretly, and the like. Therefore, after the user installs these applications, power consumption rises due to malicious power consumption of these applications, thereby further reducing a battery endurance capability, and reducing user experience.

An existing intelligent terminal generally guides the user to stop or uninstall applications with relatively high power consumption in a manner of collecting statistics on power consumption of all applications on the intelligent terminal to rank applications with high power consumption.

For such a manner, an application covered in the ranking may be one that is desired and frequently used by the user, for example, an online video application frequently used by the user. This application frequently uses the CPU due to video decoding, online video watching requires Internet connection and consumes many network resources, and usually screen brightness is relatively high when the user watches a video. Such an application naturally has high power consumption; according to the manner of the prior art, this application is often ranked high among power-consuming applications. From another point of view, this ranking manner in the prior art cannot accurately identify undesirable applications that consume power maliciously, and therefore cannot effectively avoid impact of these undesirable applications on the battery endurance capability of the intelligent terminal.

### SUMMARY

Embodiments of the present disclosure provide a method and an apparatus for clearing a malicious power-consuming application, and a user terminal, which are used to accurately identify and clear a malicious power-consuming application, to improve a battery endurance capability of an intelligent terminal.

According to a first aspect, an embodiment of the present disclosure provides a method for clearing a malicious power-consuming application, including calculating, according to a first period, background working power consumption of each application that is running in a user terminal, and when the background working power consumption is not less than a power consumption threshold, determining the application as a malicious power-consuming application; and/or calculating, according to a second period, a wakelock occupying time of each application that is running in the user terminal in a case in which a screen is turned off, and when the wakelock occupying time is not less than a time threshold, and the application is a background working application, determining the application as a malicious power-consuming application; and clearing or instructing a user to clear the determined malicious power-consuming application.

With reference to the first aspect, in a first possible implementation manner, the calculating background working power consumption of each application that is running in a user terminal includes starting from a moment when a last time of charging the user terminal ends, for each running application, periodically calculating, according to the first period, power consumption during occupation of a CPU of the user terminal, power consumption during holding of a wakelock, and power consumption during occurrence of data traffic when the running application works in the background; and calculating a sum of the power consumption during the occupation of the CPU of the user terminal, the power consumption during the holding of the wakelock, and the power consumption during the occurrence of the data traffic, as the background working power consumption of each running application.

With reference to the first possible implementation manner of the first aspect, in a second possible implementation manner, the calculating power consumption during occupation of a CPU of the user terminal when the running application works in the background includes, for each application, calculating a product of an accumulated working duration for which the application works in the background and occupies the CPU and unit-time power consumption of a corresponding frequency, to obtain the power consumption during the occupation of the CPU of the user terminal when the application works in the background; wherein the calculating power consumption during holding of a wakelock when the application works in the background includes, for each application, calculating a product of an accumulated duration for which the CPU of the user terminal is IDLE when the application works in the background and unit-time power consumption when the CPU of the user terminal is IDLE, to obtain the power consumption during the holding of the wakelock when the application works in the background; and wherein the calculating power consumption during occurrence of data traffic when the application works in the background includes, for each application, calculating a product of a quantity of bytes of accumulated data traffic generated when the application works in the background and power consumption of a single byte, to obtain the power consumption during the occurrence of the data traffic when the application works in the background.

With reference to the first aspect, in a third possible implementation manner, the wakelock occupying time of each application in the user terminal in the case in which the screen is turned off is detected using a system framework layer.

With reference to the first to third possible implementation manners of the first aspect, in a fourth possible implementation manner, the first period and the second period are timed according to a working period excluding a sleep period of the CPU.

With reference to the first to third possible implementation manners of the first aspect, in a fifth possible implementation manner, the method further includes, when a battery level of the user terminal is less than a set battery level threshold, or when the user sends an instruction for viewing a list of background power-consuming applications, triggering an operation of calculating background working power consumption of each application that is running in the current user terminal and/or a wakelock occupying time of each application that is running in the current user terminal in the case in which the screen is turned off; determining an application whose background working power consumption is not less than the power consumption threshold and/or a background application whose wakelock occupying time in the user terminal in the case in which the screen is turned off is not less than the time threshold as a malicious power-consuming application; and ranking determined malicious power-consuming applications according to the power consumption or the wakelock occupying time, to generate a list of the malicious power-consuming applications, and sending, to the user, a notification message carrying the list of the malicious power-consuming applications.

According to a second aspect, an embodiment of the present disclosure provides an apparatus for clearing a malicious power-consuming application, including a calculating module configured to calculate, according to a first period, background working power consumption of each application that is running in a user terminal, and calculate, according to a second period, a wakelock occupying time of each application that is running in the user terminal in a case in which a screen is turned off; a determining module configured to determine whether the background working power consumption of each application calculated by the calculating module is not less than a power consumption threshold, and if yes, determine the application as a malicious power-consuming application and determine whether the wakelock occupying time of each application calculated by the calculating module is not less than a time threshold, and if yes, and the application is a background working application, determine the application as a malicious power-consuming application; and a clearing module configured to clear or instruct a user to clear each determined malicious power-consuming application.

With reference to the second aspect, in a first possible implementation manner, the calculating module is configured to, starting from a moment when a last time of charging the user terminal ends, for each running application, periodically calculate, according to the first period, power consumption during occupation of a CPU of the user terminal, power consumption during holding of a wakelock, and power consumption during occurrence of data traffic when the running application works in the background; and calculate a sum of the power consumption during the occupation of the CPU of the user terminal, the power consumption during the holding of the wakelock, and the power consumption during the occurrence of the data traffic, as the background working power consumption of each running application.

With reference to the first possible implementation manner of the second aspect, in a second possible implementation manner, the calculating module is configured to, for each application, calculate a product of an accumulated working duration for which the application works in the background and occupies the CPU and unit-time power consumption of a corresponding frequency, to obtain the power consumption during the occupation of the CPU of the user terminal when the application works in the background; for each application, calculate a product of an accumulated duration for which the CPU of the user terminal is IDLE when the application works in the background and unit-time power consumption when the CPU of the user terminal is IDLE, to obtain the power consumption during the holding of the wakelock when the application works in the background; and for each application, calculate a product of a quantity of bytes of accumulated data traffic generated when the application works in the background and power consumption of a single byte, to obtain the power consumption during the occurrence of the data traffic when the application works in the background.

With reference to the second aspect, in a third possible implementation manner, the calculating module is configured to detect, using a system framework layer, the wakelock occupying time of each application in the user terminal in the case in which the screen is turned off.

With reference to the first to third possible implementation manners of the second aspect, in a fifth possible implementation manner, the calculating module is configured to time the first period and the second period according to a working period excluding a sleep period of the CPU.

With reference to the first to third possible implementation manners of the second aspect, in a sixth possible implementation manner, the calculating module is further configured to, when a battery level of the user terminal is less than a battery level threshold, or when the user sends an instruction for viewing a list of background power-consuming applications, trigger an operation of calculating background working power consumption of each application that is running in the current user terminal and/or a wakelock occupying time of each application that is running in the current user terminal in the case in which the screen is turned off; the determining module is further configured to, when a battery level of the user terminal is less than a battery level threshold, or when the user sends an instruction for viewing a list of background power-consuming applications, determine an application whose current power consumption is not less than the power consumption threshold and/or a background application whose wakelock occupying time in the user terminal in the case in which the screen is turned off is not less than the time threshold as a malicious power-consuming application; and the clearing module is further configured to, when a battery level of the user terminal is less than a battery level threshold, or when the user sends an instruction for viewing a list of background power-consuming applications, rank determined malicious power-consuming applications according to the power consumption or the wakelock occupying time, to generate a list of the malicious power-consuming applications, and send, to the user, a notification message carrying the list of the malicious power-consuming applications.

According to a third aspect, an embodiment of the present disclosure provides an apparatus for clearing a malicious power-consuming application, including a processor configured to calculate, according to a first period, background working power consumption of each application that is running in a user terminal; calculate, according to a second period, a wakelock occupying time of each application that is running in the user terminal in a case in which a screen is turned off; when a comparator determines that background working power consumption of an application is not less than a first power consumption threshold, determine the application as a malicious power-consuming application, and when the comparator determines that wakelock occupying time of an application is not less than a time threshold, determine the application as a malicious power-consuming application; and clear the determined power-consuming application, or send, using a transceiver, a notification to a user to clear the determined power-consuming application; wherein the comparator is configured to determine whether the background working power consumption of each application calculated by the processor is not less than the first power consumption threshold, and determine whether the wakelock occupying time of each application calculated by the processor is not less than the time threshold; and wherein the transceiver is configured to send a notification to the user to clear the determined malicious power-consuming application.

According to a fourth aspect, an embodiment of the present disclosure provides a user terminal, where the user terminal includes the foregoing apparatus for clearing a malicious power-consuming application provided by the embodiments of the present disclosure.

Beneficial effects of the embodiments of the present disclosure include the following.

According to the method and the apparatus for clearing a malicious power-consuming application, and the user terminal provided by the embodiments of the present disclosure, background working power consumption of each application that is running in a user terminal is periodically calculated; an application whose background working power consumption is not less than a power consumption threshold is determined as a malicious power-consuming application; and wakelock occupying time of each application in the user terminal in a case in which a screen is turned off is periodically calculated, and if an application whose wakelock occupying time is not less than a time threshold is a background working application, the application is determined as a malicious power-consuming application. These applications are applications that improperly occupy resources in the background, but are not applications that consume much power but are normally used by a user, such that the malicious power-consuming applications are accurately identified and detected, and unnecessary power consumption of the user terminal is avoided while user experience is ensured, thereby saving electric energy, and improving a battery endurance capability of the user terminal to some extent.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a flowchart of a method for clearing a malicious power-consuming application according to an embodiment of the present disclosure;

FIG. 2 is a flow block diagram of an instance according to an embodiment of the present disclosure;

FIG. 3 is a schematic diagram of a UI interface of a high power consumption application according to an embodiment of the present disclosure;

FIG. 4 is a first schematic structural diagram of an apparatus for clearing a malicious power-consuming application according to an embodiment of the present disclosure; and

FIG. 5 is a second schematic structural diagram of an apparatus for clearing a malicious power-consuming application according to an embodiment of the present disclosure.

### DESCRIPTION OF EMBODIMENTS

Implementation manners of the method and the apparatus for clearing a malicious power-consuming application, and a user terminal provided by the embodiments of the present disclosure are described below with reference to the accompanying drawings of this specification.

First, the method for clearing a malicious power-consuming application provided by an embodiment of the present disclosure is described in detail.

Based on the manner in which an application consumes power maliciously in an existing user terminal, it is found that a malicious power-consuming application generally may consume power of a user terminal in the following two manners.

One manner is that in a case in which the user terminal is normally used, an application improperly uses resources in the background, which causes high power consumption; and the other manner is that in a situation that a screen is turned off (that is, a situation that a user does not need to use a mobile phone, which is also referred to as a situation of a black screen), a background application continuously holds a wakelock (where a wakelock is a lock mechanism, and as long as an application program holds a wakelock, the system cannot enter a sleep state), such that the system cannot sleep, which causes malicious power consumption.

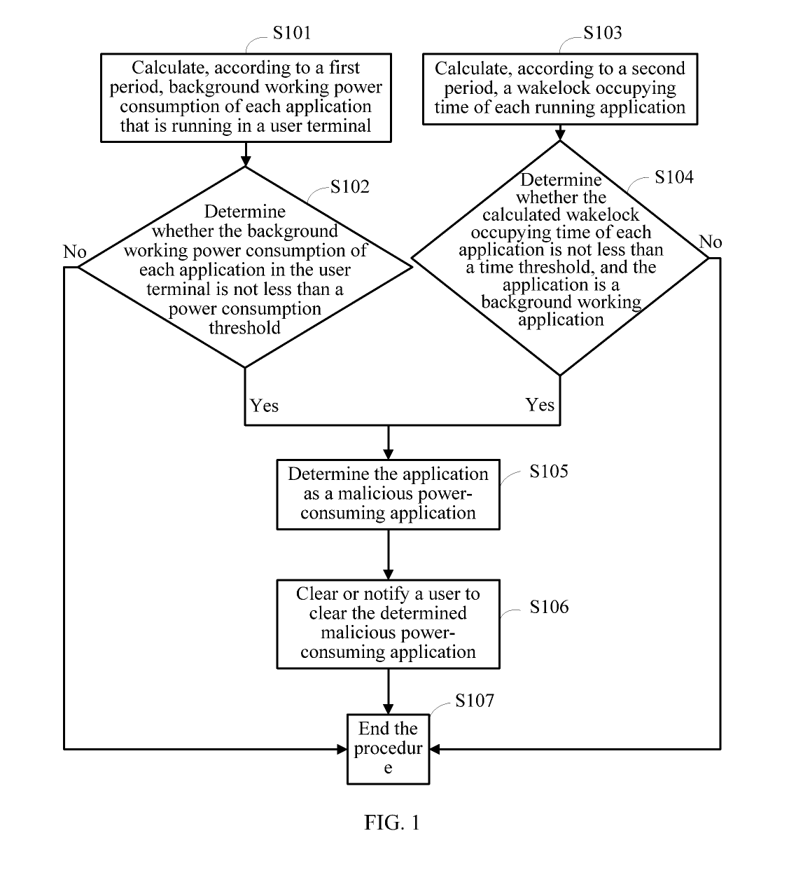

Therefore, for the foregoing two manners, to accurately detect a malicious power-consuming application (which is not a normal application required by the user), an embodiment of the present disclosure provides a method for clearing a malicious power-consuming application. As shown in FIG. 1, the method includes the following steps.

S101: Calculate, according to a first period, background working power consumption of each application that is running in a user terminal.

S102: Determine whether the background working power consumption of each application that is running in the user terminal is not less than a power consumption threshold (which is referred to as a first power consumption threshold below for ease of description), and if yes, perform the following step S105; and if not, go to the following step S107.

S103: Calculate, according to a second period, a wakelock occupying time of each running application.

S104: Determine whether the calculated wakelock occupying time of each application is not less than a time threshold, and the application is a background working application; and if yes, go to step S105; and if not, go to the following step S107.

S105: Determine the application as a malicious power-consuming application, and then perform the following step S106.

S106: Clear or instruct a user to clear the determined malicious power-consuming application.

S107: End the procedure.

In the foregoing procedure, S101 to S102, and S103 to S104 are two independent manners for detecting a malicious power-consuming application, and one of the two manners may be selected and implemented, or both of the two manners may be implemented. During implementation, if both of the two manners are implemented, the two manners may be implemented simultaneously or sequentially.

In the foregoing procedure, the first period and the second period are not timed according to physical time, but preferably are timed according to a working period excluding a sleep period of a CPU of the user terminal.

Because malicious power consumption of an application in a user terminal is different from power consumption during normal use of a user, a malicious power consumption manner includes but is not limited to that: an application frequently applies for a real-time clock (RTC) to wake up the CPU, and data traffic occurs after the CPU is woken up; an application holds a wakelock for a long time in a case in which a screen is turned off, and the like. Therefore, in this embodiment of the present disclosure, accumulated power consumption during occupation of the CPU of the user terminal when an application works in the background may be calculated based on the several manners in which an application consumes power maliciously in the background.

Further, in the foregoing step S101, calculating background working power consumption of each application that is running in a user terminal may be implemented in the following manner: starting from a moment when a last time of charging the user terminal ends, for each running application, periodically calculating, according to the first period, power consumption during occupation of the CPU of the user terminal, power consumption during holding of a wakelock, and power consumption during occurrence of data traffic when the running application works in the background; and calculating a sum of the power consumption during the occupation of the CPU of the user terminal, the power consumption during the holding of the wakelock, and the power consumption during the occurrence of the data traffic, as the background working power consumption of each application that is running in the user terminal.

In a special case, because many existing user terminals can be charged through a universal serial bus (USB) interface when being connected to a personal computer (PC), when a user connects the user terminal to the PC to perform a short time operation (such as downloading and/or uploading a multimedia file, or updating an application program) on the user terminal, the PC may charge the user terminal through, for example, the USB interface. However, in this case, the user may not need to charge the user terminal, and the user terminal is slightly charged. To avoid impact on performance of the user terminal caused by frequently calculating the power consumption accumulated when each application works in the background, even if the user ends the operation on the user terminal and USB charging is ended accordingly, the end of charging is not determined as a real “end of charging” if a USB charge level at this time is less than a set threshold or a charging time is less than a set duration, and an operation of periodically calculating, according to the first period, power consumption during occupation of the CPU of the user terminal, power consumption during holding of a wakelock, and power consumption during occurrence of data traffic when the application that is running in the user terminal works in the background is not triggered.

Further, the foregoing step of calculating power consumption during occupation of the CPU of the user terminal when each application works in the background is implemented using the following step: for each application, calculating a product of an accumulated working duration for which the application works in the background and occupies the CPU and unit-time power consumption of a corresponding frequency (that is, CPU power consumption=CPU background working time×Unit-time power consumption of a corresponding frequency), to obtain the power consumption during the occupation of the CPU of the user terminal when the application works in the background.

Further, calculating power consumption during the holding of a wakelock when each application works in the background is implemented using the following step: for each application, calculating a product of a duration for which the CPU of the user terminal is IDLE when the application works in the background and unit-time power consumption when the CPU of the user terminal is IDLE (Power consumption during holding of a wakelock=Accumulated duration for which the CPU is IDLE×Unit-time power consumption when the CPU is IDLE), to obtain the power consumption during the holding of the wakelock when the application works in the background.

Further, calculating power consumption during occurrence of data traffic when each application works in the background is implemented using the following step: for each application, calculating a product of a quantity of bytes of accumulated data traffic generated when the application works in the background and power consumption of a single byte, to obtain the power consumption during the occurrence of the data traffic when the application works in the background.

For a common user terminal, such as a mobile phone, or a tablet computer that can be connected to a wireless network, a source of accumulated data traffic generated when the application works in the background is mainly a sum of traffic generated by the user terminal using a wireless local area network such as a WIFI network and data traffic generated by the user terminal using an operator network such as a second generation (2G) or 3G network.

Further, in the foregoing step S103, the wakelock occupying time of each application may be detected using a system framework layer. Once it is found that the wakelock occupying time is not less than a time threshold (for example, 15 minutes), the application is determined as a malicious power-consuming application. The specific detection manner belongs to the prior art, and is not described herein again.

Further, in a possible implementation manner of this embodiment of the present disclosure, before performing the foregoing step S106, the following steps may also be performed: determining, according to a locally saved list of applications selected by the user to be ignored in processing, whether the malicious power-consuming application that is determined in steps S101 to S102 and steps S103 to S104 was selected by the user to be ignored in processing; and if yes, neither clearing the application nor sending a notification about the malicious power-consuming application; and if not, performing the subsequent step of clearing or instructing the user to clear the determined malicious power-consuming application.

In still another situation, if calculated background working power consumption of an application is extremely large, that is, if the application is an extraordinarily malicious power-consuming application, it is not required to determine a condition such as whether the malicious power-consuming application is ignored, and a notification of the malicious power-consuming application is directly sent to the user. After it is determined, by means of calculation, that the background working power consumption of the application is greater than a first power consumption threshold, before the determining whether the malicious power-consuming application is selected by the user to be ignored in processing, the following step may also be performed: determining whether the background working power consumption of the application is not less than a greater power consumption threshold (which is referred to as a second power consumption threshold below for ease of description), where the second power consumption threshold is greater than the first power consumption threshold, for example, the first power consumption threshold is 10 milliampere-hours (maH), and the second power consumption threshold is 50 maH; and if yes, immediately instructing the user to clear the application; and if not, performing the foregoing step of determining whether the malicious power-consuming application was ignored in processing by the user.

Further, in the foregoing step S106, the determined malicious power-consuming application may be directly cleared in the following case: it is found that the determined malicious power-consuming application is in a saved blacklist of malicious power-consuming applications, and was marked as being manually cleared.

A clearing process includes an operation of closing the malicious power-consuming application and/or uninstalling the malicious power-consuming application.

In the foregoing step S106, the process of instructing the user to clear the application includes ranking determined malicious power-consuming applications according to the power consumption or the wakelock occupying time, to generate a list of the malicious power-consuming applications, and sending, to the user, a notification message carrying the list of the malicious power-consuming applications; when receiving an instruction for ignoring the malicious power-consuming applications that is returned by the user, using malicious power-consuming applications that are selected by the user to be ignored in processing to update the locally saved list of applications selected by the user to be ignored in processing; or when receiving an instruction for clearing the malicious power-consuming applications that is returned by the user, stopping running or uninstalling malicious power-consuming applications that are selected by the user, and marking the malicious power-consuming applications as having been manually cleared.

Preferably, to avoid frequently instructing the user of the list of the malicious power-consuming applications in a short period of time, and avoid affecting user experience of a normal application in the user terminal, in this embodiment of the present disclosure, a notification sending frequency may be properly reduced on the following conditions: each list of malicious power-consuming applications detected and generated according to the first period is saved for a set time, and is deleted after the set time elapses; in addition, before the notification message carrying the list of the malicious power-consuming applications is sent, a saved list of malicious power-consuming applications generated in this period is compared with a list of malicious power-consuming applications generated in a last period, and if the two lists include same malicious power-consuming applications (ranking may be different), sending of the notification message is suspended; and if an interval between a moment when the notification message carrying the list of the malicious power-consuming applications is sent this time and a moment when the notification message carrying the list of the malicious power-consuming applications is sent last time is less than a time interval (for example, 4 hours), sending of the notification message is suspended.

In this way, under the premise of ensuring that the malicious power-consuming applications are effectively detected, the frequency of sending the notification message of the malicious power-consuming applications can be properly reduced, to avoid interference to the process in which the user normally uses the user terminal.

Preferably, in some cases, detecting and finding malicious power-consuming applications of a user terminal in time is quite necessary for prolonging normal service time of the user terminal, for example, when a battery level of the user terminal is less than a relatively small battery level threshold (for example, 20%), or when the user actively sends an instruction for viewing a background application list, the operation of calculating background working power consumption of each application that is running in the current user terminal and/or a wakelock occupying time of each application that is running in the current user terminal in a case in which the screen is turned off is triggered.

An application whose power consumption is not less than the first power consumption threshold and/or a background application whose wakelock occupying time in the user terminal in the case in which the screen is turned off is not less than the time threshold is determined as a malicious power-consuming application.

Determined malicious power-consuming applications are ranked according to the power consumption or the wakelock occupying time, to generate a list of the malicious power-consuming applications, and a notification message carrying the list of the malicious power-consuming applications is sent to the user.

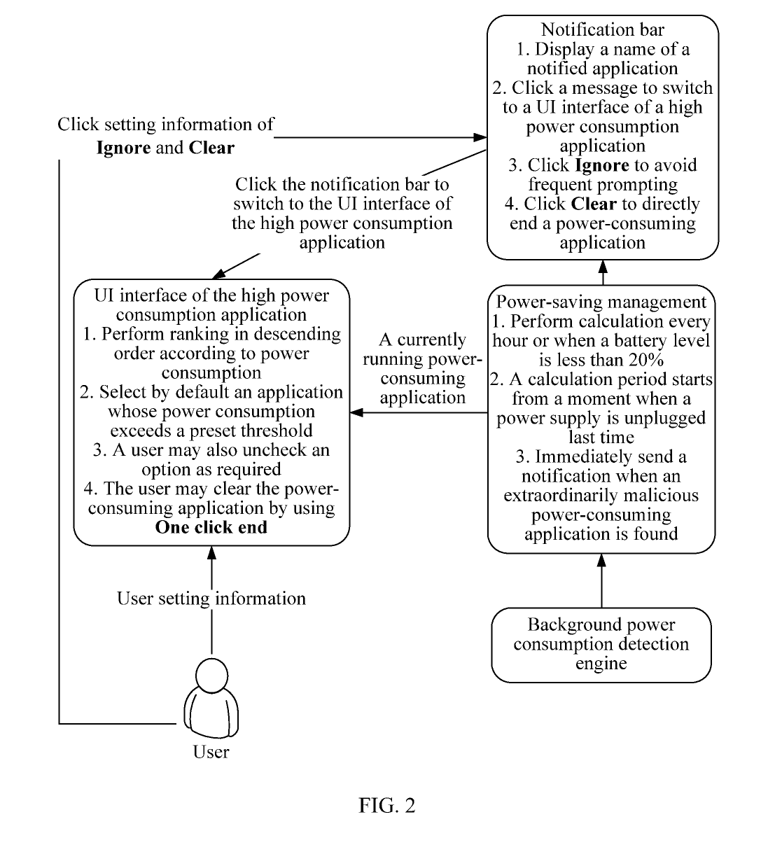

To better describe the foregoing method for clearing a malicious power-consuming application provided by this embodiment of the present disclosure, description is provided below using a flow block diagram of an instance shown in FIG. 2.

A background working power consumption detection engine in the user terminal for detecting a malicious power-consuming application calculates, starting from a moment when a last time of charging the user terminal ends (for example, a charging power supply of the user terminal is unplugged), accumulated power consumption during background working of each application in the user terminal every hour; when a battery level of the user terminal is less than 20%, calculates background working power consumption of each application that is running in the user terminal; and determines malicious power-consuming applications (if an extraordinarily malicious power-consuming application is found, immediately sends a notification message to the user).

When a condition of sending a notification message is met (for example, compared with a last time, the malicious power-consuming applications in a list of malicious power-consuming applications change, and more than 4 hours has passed since a last time a notification message is sent), a corresponding notification bar message is sent to the user, where the notification bar message notifies the user that several malicious power-consuming applications are detected and brief information such as icons of the malicious power-consuming applications are enumerated. If the user clicks the message, switch to a user interface (UI) of a high power consumption application; if the user directly clicks “Ignore the message” in the notification bar message, a frequency of sending a notification bar message subsequently is further reduced, such that frequent prompting is avoided; if the user clicks “Clear”, running of the determined malicious power-consuming applications is directly stopped.

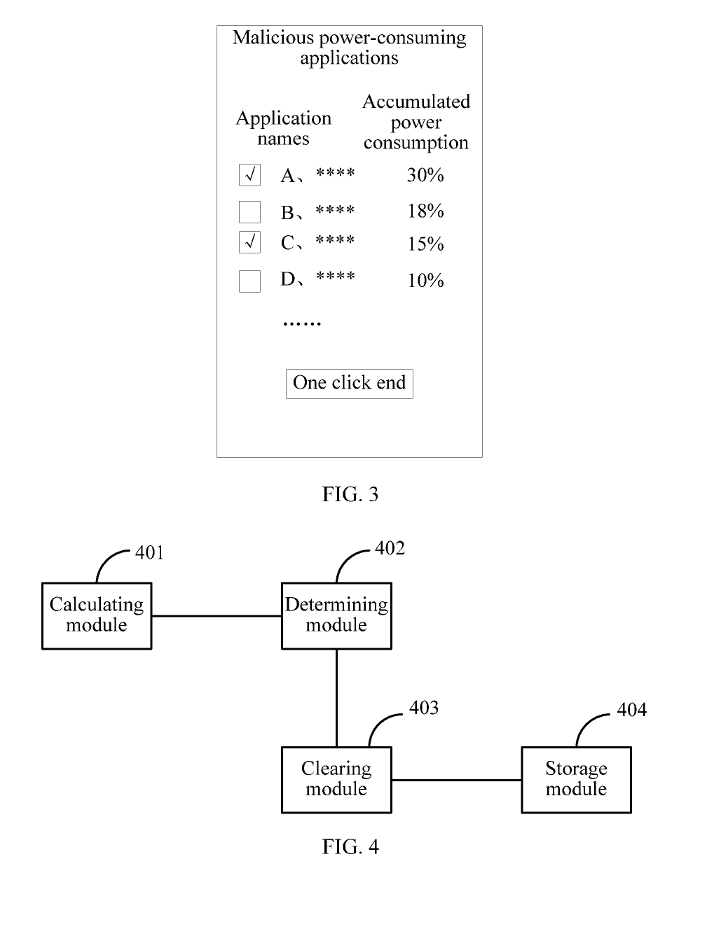

After the UI interface of the high power consumption application is entered, as shown in FIG. 3, the interface displays a list of malicious power-consuming applications that are ranked according to power consumption in descending order (the applications in the list are applications whose background working power consumption is not less than a set power consumption threshold by default), provides power consumption information related to each malicious power-consuming application, and selects several high power consumption applications by default. The interface also provides a corresponding check box for each application in the list, such that the user may deselect an application in the list as required, and select “One click end” to clear the power-consuming applications.

Based on a same idea, an embodiment of the present disclosure further provides an apparatus for clearing a malicious power-consuming application, and a user terminal. Because principles of the apparatus and the user terminal for resolving problems are similar to those of the foregoing method for clearing a malicious power-consuming application, for implementation of the apparatus and the user terminal, refer to implementation of the foregoing method for clearing a malicious power-consuming application, and repeated parts are not described again.

In a first possible implementation manner of the apparatus for clearing a malicious power-consuming application provided by this embodiment of the present disclosure, as shown in FIG. 4, the apparatus includes a calculating module 401 configured to calculate, according to a first period, background working power consumption of each application that is running in a user terminal; and calculate, according to a second period, a wakelock occupying time of each application that is running in the user terminal in a case in which a screen is turned off; a determining module 402 configured to determine whether the background working power consumption of each application calculated by the calculating module 401 is not less than a power consumption threshold (which is referred to as a first power consumption threshold below for ease of description), and if yes, determine the application as a malicious power-consuming application; and determine whether the accumulated wakelock occupying time of each application calculated by the calculating module 401 is not less than a time threshold, and if yes, and the application is a background working application, determine the application as a malicious power-consuming application; and a clearing module 403 configured to clear or instruct a user to clear the determined malicious power-consuming application.

Further, the calculating module 401 is configured to, starting from a moment when a last time of charging the user terminal ends, for each running application, periodically calculate, according to the first period, power consumption during occupation of a CPU of the user terminal, power consumption during holding of a wakelock, and power consumption during occurrence of data traffic when the running application works in the background; and calculate a sum of the power consumption during the occupation of the CPU of the user terminal, the power consumption during the holding of the wakelock, and the power consumption during the occurrence of the data traffic, as the background working power consumption of each application that is running in the user terminal.

Further, the calculating module 401 is configured to, for each application, calculate a product of an accumulated working duration for which the application works in the background and occupies the CPU and unit-time power consumption of a corresponding frequency, to obtain the power consumption during the occupation of the CPU of the user terminal when the application works in the background; for each application, calculate a product of an accumulated duration for which the CPU of the user terminal is IDLE when the application works in the background and unit-time power consumption when the CPU of the user terminal is IDLE, to obtain the power consumption during the holding of the wakelock when the application works in the background; and for each application, calculate a product of a quantity of bytes of accumulated data traffic generated when the application works in the background and power consumption of a single byte, to obtain the power consumption during the occurrence of the data traffic when the application works in the background.

Further, the calculating module 401 is configured to detect, using a system framework layer, the wakelock occupying time of each application in the user terminal in the case in which the screen is turned off.

Further, the calculating module 401 is configured to time the first period and the second period according to a working period excluding a sleep period of the CPU.

Further, the clearing module 403 is further configured to, before clearing or instructing the user to clear the determined malicious power-consuming application, determine, according to a locally saved list of applications selected by the user to be ignored in processing, whether the malicious power-consuming application was selected by the user to be ignored in processing; and if not, determine that the subsequent step of clearing or instructing the user to clear the determined malicious power-consuming application is to be performed.

Further, the clearing module 403 is further configured to, when calculated background working power consumption of an application is greater than the first power consumption threshold, before determining whether the malicious power-consuming application was selected by the user to be ignored in processing, determine whether the calculated background working power consumption is not less than a set power consumption threshold (which is referred to as a second power consumption threshold below for ease of description), where the second power consumption threshold is greater than the first power consumption threshold; if yes, instruct the user to clear the application; and if not, perform the step of determining whether the malicious power-consuming application was ignored in processing by the user.

Further, as shown in FIG. 4, the apparatus for clearing a malicious power-consuming application provided by this embodiment of the present disclosure further includes a storage module 404 configured to store a list of malicious power-consuming applications that are selected by the user to be ignored in processing.

Correspondingly, the clearing module 403 is configured to rank determined malicious power-consuming applications according to the power consumption or the wakelock occupying time, to generate a list of the malicious power-consuming applications, and send, to the user, a notification message carrying the list of the malicious power-consuming applications; when receiving an instruction for ignoring the malicious power-consuming applications that is returned by the user, use the malicious power-consuming applications that are selected by the user to be ignored in processing to update the list of the applications selected by the user to be ignored in processing that is saved by the storage module 404; and when receiving an instruction for clearing the malicious power-consuming applications that is returned by the user, stop running or uninstall the malicious power-consuming applications that are selected by the user, and mark the malicious power-consuming applications as having been manually cleared.

Further, the storage module 404 is further configured to save, for a set time, each list of malicious power-consuming applications that is generated according to the first period.

Correspondingly, the clearing module 403 is further configured to, before the step of sending, to the user, a notification message carrying the list of the malicious power-consuming applications, compare a list of malicious power-consuming applications that is generated in this period and saved by the storage module 404 with a list of malicious power-consuming applications that is generated in a last period and saved by the storage module 404, and if the two lists include same malicious power-consuming applications, suspend sending the notification message; if the two lists include different malicious power-consuming applications, go to the step of sending, to the user, a notification message carrying the list of the malicious power-consuming applications that is generated in this period.

Further, the calculating module 401 is configured to, when a battery level of the user terminal is less than a battery level threshold, or when the user sends an instruction for viewing a list of background power-consuming applications, trigger an operation of calculating background working power consumption of each application that is running in the current user terminal and/or a wakelock occupying time of each application in the current user terminal in the case in which the screen is turned off.

Correspondingly, the determining module 402 is further configured to, when a battery level of the user terminal is less than a battery level threshold, or when the user sends an instruction for viewing a list of background power-consuming applications, determine an application whose current background working power consumption is not less than the first power consumption threshold and/or a background application whose wakelock occupying time in the user terminal in the case in which the screen is turned off is not less than the time threshold as a malicious power-consuming application.

Correspondingly, the clearing module 403 is further configured to, when a battery level of the user terminal is less than a battery level threshold, or when the user sends an instruction for viewing a list of background power-consuming applications, rank determined malicious power-consuming applications according to the power consumption or the wakelock occupying time, to generate a list of the malicious power-consuming applications, and send, to the user, a notification message carrying the list of the malicious power-consuming applications.

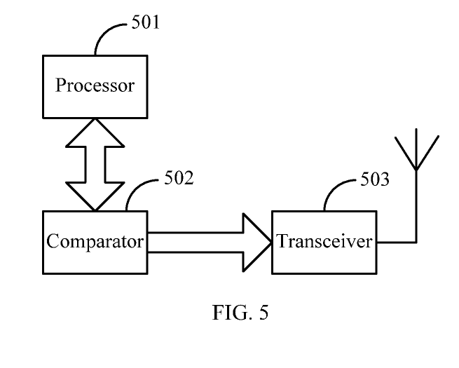

In a second possible implementation manner of the apparatus for clearing a malicious power-consuming application provided by this embodiment of the present disclosure, as shown in FIG. 5, the apparatus includes a processor 501 configured to calculate, according to a first period, background working power consumption of each application that is running in a user terminal; calculate, according to a second period, a wakelock occupying time of each application that is running in the user terminal in a case in which a screen is turned off; when a comparator 502 determines that background working power consumption of an application is not less than a first power consumption threshold, determine the application as a malicious power-consuming application, and when the comparator 502 determines that wakelock occupying time of an application is not less than a time threshold, determine the application as a malicious power-consuming application; and clear the determined power-consuming application, or send, using a transceiver 503, a notification to a user to clear the determined power-consuming application; and the comparator 502 is configured to determine whether the background working power consumption of each application calculated by the processor 501 is not less than the first power consumption threshold, and determine whether the wakelock occupying time of each application calculated by the processor 501 is not less than the time threshold; and the transceiver 503 is configured to send a notification to the user to clear the determined malicious power-consuming application.

An embodiment of the present disclosure further provides a user terminal, where the user terminal includes the foregoing apparatus for clearing a malicious power-consuming application.

According to the method and the apparatus for clearing a malicious power-consuming application, and the user terminal provided by the embodiments of the present disclosure, background working power consumption of each application in a user terminal is periodically calculated, an application whose background working power consumption is not less than a power consumption threshold is determined as a malicious power-consuming application; and a wakelock occupying time of each application in the user terminal in a case in which a screen is turned off is periodically calculated, and if an application whose wakelock occupying time is not less than a time threshold is a background working application, the application is determined as a malicious power-consuming application. These applications are applications that improperly occupy resources in the background, but are not applications that consume much power but are normally used by a user, such that the malicious power-consuming applications are accurately identified and detected, and unnecessary power consumption of the user terminal is avoided while user experience is ensured, thereby saving electric energy, and improving a battery endurance capability of the user terminal to some extent.

According to the descriptions of the foregoing implementation manners, a person skilled in the art may clearly understand that the embodiments of the present disclosure may be implemented using hardware, or may be implemented in a manner of software plus a necessary general hardware platform. Based on such an understanding, the technical solutions of the present disclosure may be implemented in a form of a software product. The software product may be stored in a non-volatile storage medium (which may be a compact disc read-only memory (CD-ROM), a universal serial bus (USB) flash drive, a removable hard disk, or the like) and includes several instructions for instructing a computer device (which may be a personal computer, a server, a network device, or the like) to execute the methods described in the embodiments of the present disclosure.

A person skilled in the art may understand that the accompanying drawings are merely schematic diagrams of exemplary embodiments, and modules or processes in the accompanying drawings are not necessarily required for implementing the present disclosure.

A person skilled in the art may understand that the modules in the apparatuses provided in the embodiments may be arranged in the apparatuses in a distributed manner according to the description of the embodiments, or may be arranged in one or more apparatuses which are different from those described in the embodiments. The modules in the foregoing embodiments may be combined into one module, or split into a plurality of submodules.

The sequence numbers of the foregoing embodiments of the present disclosure are merely for illustrative purposes, and are not intended to indicate priorities of the embodiments.

A person skilled in the art can make various modifications and variations to the present disclosure without departing from the spirit and scope of the present disclosure. The present disclosure is intended to cover these modifications and variations provided that they fall within the scope of protection defined by the following claims and their equivalent technologies.

What is claimed is:

1. A method for clearing a malicious power-consuming application, comprising:
performing at least one of:
calculating, according to a first period, background working power consumption of each application that is running in a user terminal, and when the background working power consumption of a first application is not less than a power consumption threshold, determining the first application as a malicious power-consuming application, and
calculating, according to a second period, a wakelock occupying time of each application that is running in the user terminal in a case in which a screen is turned off, and when the wakelock occupying time of a second application is not less than a time threshold, and the second application is a background working application, determining the second application as a malicious power-consuming application; and
performing at least one of:
clearing the determined malicious power-consuming application; and
instructing a user to clear the determined malicious power-consuming application.

2. The method according to claim 1, wherein calculating the background working power consumption of each application that is running in the user terminal comprises:
periodically calculating, starting from a moment when a last time of charging the user terminal ends, for each running application, according to the first period, power consumption during occupation of a central processing unit (CPU) of the user terminal, power consumption during holding of a wakelock, and power consumption during occurrence of data traffic, when the running application works in the background; and
calculating a sum of the power consumption during the occupation of the CPU of the user terminal, the power consumption during the holding of the wakelock, and the power consumption during the occurrence of the data traffic, as the background working power consumption of each running application.

3. The method according to claim 2, wherein calculating the power consumption during occupation of the CPU of the user terminal when the running application works in the background comprises calculating, for each application, a product of an accumulated working duration for which the application works in the background and occupies the CPU and unit-time power consumption of a corresponding frequency, to obtain the power consumption during the occupation of the CPU of the user terminal when the application works in the background,
wherein calculating the power consumption during the holding of the wakelock when the running application works in the background comprises, for each application, calculating a product of an accumulated duration for which the CPU of the user terminal is IDLE when the application works in the background and unit-time power consumption when the CPU of the user terminal is IDLE, to obtain the power consumption during the holding of the wakelock when the application works in the background, and
wherein calculating the power consumption during occurrence of data traffic when the running application works in the background comprises, for each application, calculating a product of a quantity of bytes of accumulated data traffic generated when the application works in the background and power consumption of a single byte, to obtain the power consumption during the occurrence of the data traffic when the application works in the background.

4. The method according to claim 1, wherein the wakelock occupying time of each application in the user terminal in the case in which the screen is turned off is detected using a system framework layer.

5. The method according to claim 1, wherein the first period and the second period are timed according to a working period excluding a sleep period of a CPU of the user terminal.

6. The method according to claim 1, further comprising:
triggering, when at least one of a battery level of the user terminal is less than a set battery level threshold and the user sends an instruction for viewing a list of background power-consuming applications, an operation of calculating at least one of background working power consumption of each application that is running in the user terminal and the wakelock occupying time of each application that is running in the user terminal in the case in which the screen is turned off;
determining at least one of an application whose background working power consumption is not less than the power consumption threshold and a background application whose wakelock occupying time in the user terminal in the case in which the screen is turned off is not less than the time threshold as a malicious power-consuming application; and
ranking determined malicious power-consuming applications according to at least one of the power consumption and the wakelock occupying time, to generate a list of the malicious power-consuming applications, and sending, to the user, a notification message carrying the list of the malicious power-consuming applications.

7. An apparatus for clearing a malicious power-consuming application, comprising:
a processor configured to:
calculate, according to a first period, background working power consumption of each application that is running in a user terminal; and
calculate, according to a second period, a wakelock occupying time of each application that is running in the user terminal in a case in which a screen is turned off;
a comparator configured to:
determine whether the background working power consumption of each application calculated by the processor is not less than a power consumption threshold;
determine the first application as a malicious power-consuming application when the background working power consumption of a first application is not less than the power consumption threshold; and
determine whether the wakelock occupying time of each application calculated by the processor is not less than a time threshold, and
determine the second application as a malicious power-consuming application when the wakelock occupying time of a second application is not less than the time threshold, and the second application is a background working application; and
a transceiver configured to at least one of clear the determined malicious power-consuming application and instruct a user to clear the determined malicious power-consuming application.

8. The apparatus according to claim 7, wherein the processor is configured to:
periodically calculate, starting from a moment when a last time of charging the user terminal ends and for each running application, according to the first period, power consumption during occupation of a central processing unit (CPU) of the user terminal, power consumption during holding of a wakelock, and power consumption during occurrence of data traffic, when the running application works in the background; and
calculate a sum of the power consumption during the occupation of the CPU of the user terminal, the power consumption during the holding of the wakelock, and the power consumption during the occurrence of the data traffic, as the background working power consumption of each running application.

9. The apparatus according to claim 8, wherein the processor is further configured to:
calculate, for each application, a product of an accumulated working duration for which the application works in the background and occupies the CPU and unit-time power consumption of a corresponding frequency, to obtain the power consumption during the occupation of the CPU of the user terminal when the application works in the background;
calculate, for each application, a product of an accumulated duration for which the CPU of the user terminal is IDLE when the application works in the background and unit-time power consumption when the CPU of the user terminal is IDLE, to obtain the power consumption during the holding of the wakelock when the application works in the background; and
calculate, for each application, a product of a quantity of bytes of accumulated data traffic generated when the application works in the background and power consumption of a single byte, to obtain the power consumption during the occurrence of the data traffic when the application works in the background.

10. The apparatus according to claim 7, wherein the processor is configured to detect, using a system framework layer, the wakelock occupying time of each application in the user terminal in the case in which the screen is turned off.

11. The apparatus according to claim 7, wherein the processor is configured to time the first period and the second period according to a working period excluding a sleep period of a CPU of the user terminal.

12. The apparatus according to claim 7, wherein the processor is further configured to, when at least one of a battery level of the user terminal is less than a battery level threshold and the user sends an instruction for viewing a list of background power-consuming applications, trigger an operation of calculating at least one of background working power consumption of each application that is running in the user terminal and the wakelock occupying time of each application that is running in the user terminal in the case in which the screen is turned off,
wherein the comparator is further configured to, when at least one of the battery level of the user terminal is less than the battery level threshold and the user sends the instruction for viewing the list of background power-consuming applications, determine at least one of an application whose current power consumption is not less than the power consumption threshold and a background application whose wakelock occupying time in the user terminal in the case in which the screen is turned off is not less than the time threshold as a malicious power-consuming application, and
wherein the transceiver is further configured to, when at least one of the battery level of the user terminal is less than the battery level threshold and the user sends the instruction for viewing the list of background power-consuming applications, rank determined malicious power-consuming applications according to at least one of the power consumption and the wakelock occupying time, to generate a list of the malicious power-consuming applications, and send, to the user, a notification message carrying the list of the malicious power-consuming applications.

13. A user terminal comprising an apparatus for clearing a malicious power-consuming application, the apparatus comprising:
a processor configured to:
calculate, according to a first period, background working power consumption of each application that is running in a user terminal; and
calculate, according to a second period, a wakelock occupying time of each application that is running in the user terminal in a case in which a screen is turned off;
a comparator configured to:
determine whether the background working power consumption of each application calculated by the processor is not less than a power consumption threshold;
determine the first application as a malicious power-consuming application when the background working power consumption of a first application is not less than the power consumption threshold; and
determine whether the wakelock occupying time of each application calculated by the processor is not less than a time threshold, and
determine the second application as a malicious power-consuming application when the wakelock occupying time of a second application is not less than the time threshold, and the second application is a background working application; and
a transceiver configured to at least one of clear the determined malicious power-consuming application and instruct a user to clear the determined malicious power-consuming application.

14. The user terminal of claim 13, wherein the processor is configured to:
periodically calculate, starting from a moment when a last time of charging the user terminal ends and for each running application, according to the first period, power consumption during occupation of a central processing unit (CPU) of the user terminal, power consumption during holding of a wakelock, and power consumption during occurrence of data traffic, when the running application works in the background; and
calculate a sum of the power consumption during the occupation of the CPU of the user terminal, the power consumption during the holding of the wakelock, and the power consumption during the occurrence of the data traffic, as the background working power consumption of each running application.

15. The user terminal of claim 14, wherein the processor is further configured to:
calculate, for each application, a product of an accumulated working duration for which the application works in the background and occupies the CPU and unit-time power consumption of a corresponding frequency, to obtain the power consumption during the occupation of the CPU of the user terminal when the application works in the background;
calculate, for each application, a product of an accumulated duration for which the CPU of the user terminal is IDLE when the application works in the background and unit-time power consumption when the CPU of the user terminal is IDLE, to obtain the power consumption during the holding of the wakelock when the application works in the background; and
calculate, for each application, a product of a quantity of bytes of accumulated data traffic generated when the application works in the background and power consumption of a single byte, to obtain the power consumption during the occurrence of the data traffic when the application works in the background.

16. The user terminal of claim 13, wherein the processor is configured to detect, using a system framework layer, the wakelock occupying time of each application in the user terminal in the case in which the screen is turned off.

17. The user terminal of claim 13, wherein the processor is configured to time the first period and the second period according to a working period excluding a sleep period of a CPU of the user terminal.

18. The user terminal of claim 13, wherein the processor is further configured to, when at least one of a battery level of the user terminal is less than a battery level threshold and the user sends an instruction for viewing a list of background power-consuming applications, trigger an operation of calculating at least one of background working power consumption of each application that is running in the user terminal and the wakelock occupying time of each application that is running in the user terminal in the case in which the screen is turned off,
wherein the comparator is further configured to, when at least one of the battery level of the user terminal is less than the battery level threshold and the user sends the instruction for viewing the list of background power-consuming applications, determine at least one of an application whose current power consumption is not less than the power consumption threshold and a background application whose wakelock occupying time in the user terminal in the case in which the screen is turned off is not less than the time threshold as a malicious power-consuming application, and
wherein the transceiver is further configured to, when at least one of the battery level of the user terminal is less than the battery level threshold and the user sends the instruction for viewing the list of background power-consuming applications, rank determined malicious power-consuming applications according to at least one of the power consumption and the wakelock occupying time, to generate a list of the malicious power-consuming applications, and send, to the user, a notification message carrying the list of the malicious power-consuming applications.
